(19) United States
(12) Patent Application Publication
(10) Pub. No.: US 2012/0120244 A1
(43) Pub. Date: May 17, 2012

(54) ONLINE SYSTEM FOR SAMPLING NIGHTCLUB ACTIVITY

(76) Inventor: Attila Rymarz, Boynton Beach, FL (US)

(21) Appl. No.: 13/295,833

(22) Filed: Nov. 14, 2011

Related U.S. Application Data
(60) Provisional application No. 61/456,793, filed on Nov. 12, 2010.

(51) Int. Cl. H04N 7/18

(52) U.S. Cl. 348/159; 348/E07.085

(57) ABSTRACT

A system for sampling and monitoring the activity of a pre-determined establishment has a data-collection device connected to a group of sensors. The data-collection device is connected to the internet. A control panel on the data-collection device controls all of the device's and the sensors' operations. The group of sensors may include a thermal imaging camera, a microphone, a thermometer, a hygrometer, and a light sensor, and may include more than one of any of these sensors. Data collected from the atmosphere of the pre-determined establishment is uploaded from the data-collection device to be presented and organized on a publicly accessible website, which is viewable by any personal computers, phones etc. that have an active internet connection. A system of rating the related establishments on the website provides users an additional method of comparing establishments and deciding where to spend their time based on their needs.

### BACKGROUND

This non-provisional patent application is based on provisional patent application Ser. No. 61/456,793 filed on Nov. 12, 2010.

Some embodiments may relate to camera monitoring systems, and more specifically, to an infrared monitoring system for use in nightclubs which uploads to the internet.

People prefer certain nightclubs or other establishments over others for a variety of reasons. Some of these reasons may include the type and volume of music being played, the number of people who are at the establishment, the type of people who visit the establishment, the temperature inside of the establishment, and the atmosphere of the establishment (e.g. lighting, size etc.) among many other reasons. Even after having visited an establishment many times, there are many factors (e.g. number of people) which may change on a night-to-night basis and which may change the desirability of a certain establishment for a certain person.

In addition, visiting all potential establishments and then deciding which would be the most fun is very often not a realistic option (due to the physical distance between the establishments, limited amount of time, using too much gasoline to travel etc.).

In light of the difficulties associated with trying to evaluate among a number of choices of establishments to visit, there is a desperate need for a means of monitoring the current activity at an establishment (e.g. the number of people, the temperature, the music, etc.) from home (i.e. on the internet) in order to determine how desirable a particular establishment would be to visit at that particular time.

While certain aspects of conventional technologies have been discussed and presented to facilitate disclosure of some embodiments, Applicants in no way disclaim these technical aspects, and it is contemplated that the attached claims may encompass one or more of the conventional technical aspects discussed herein.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is it known to be relevant to an attempt to solve any problem with which this specification is concerned.

### SUMMARY

Some embodiments may address one or more of the problems and deficiencies discussed above. However, it is contemplated that some embodiments may prove useful in addressing other problems and deficiencies in a number of technical areas. Therefore the claims should not necessarily be construed as limited to addressing any of the particular problems or deficiencies discussed herein.

Some embodiments may include a system for sampling and monitoring the activity of a pre-determined establishment that has a data-collection device connected to a group of sensors. The data-collection device is connected to the internet. A control panel on the data-collection device controls all of the device's and the sensors' operations. The group of sensors may include a thermal imaging camera, a microphone, a thermometer, a hygrometer, and a light sensor, and may include more than one of any of these sensors. Data collected from the atmosphere of the pre-determined establishment is uploaded from the data-collection device to be presented and organized on a publicly accessible website, which is viewable by any personal computers, phones etc. that have an active internet connection. A system of rating the related establishments on the website provides users an additional method of comparing establishments and deciding where to spend their time based on their needs.

An advantage provided by certain embodiments is that the online system provides multiple methods for users to evaluate choices on where to spend their time in a manner that is far more convenient and faster than needing to physically visit the potential establishments.

These and other advantages of some embodiments are more readily apparent with reference to the detailed description and accompanying drawings.

### BRIEF DESCRIPTION OF THE DRAWINGS

For a fuller understanding of the nature of some embodiments, reference should be made to the following detailed description taken in conjunction with the accompanying drawings in which:

FIG. 1 is a schematic diagram of the online system for sampling nightclub activity according to an embodiment.

Like reference numerals refer to like parts throughout the several views of the drawings.

### DETAILED DESCRIPTION OF SOME EMBODIMENTS

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and do not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

All references herein to any features or elements of some embodiments such as but not limited to “a,” “an,” “one,” “an additional,” “another,” or “the” feature or element, or grammatical variations thereof, unless otherwise specified by limiting language such as “ONLY ONE . . . ” wherein an exact number is specified along with the world “ONLY” or “LIMITED TO”, do NOT specifically prevent the inclusion or implementation of more than one of those features or elements, nor do they specifically admit that one or more of those features or elements must be used, unless otherwise specified by the limiting language “MUST have a” or “NEEDS to include one.”

All references herein including language such as but not limited to “one or more,” “at least one,” or grammatical variants thereof are nonlimiting and may be taken to mean that none of a certain feature or element may be used, or alternatively that only a singular feature or element may be used, or alternatively that only a plurality of elements or features may be used, or alternatively that either a singular or a plurality of features or elements may be used, or alternatively that none or one or more than one features or elements may be used. The use of this terminology herein does NOT specifically admit that more than one feature or element has to be used, nor does it specifically admit that only one feature or element has to be used, unless otherwise specified by the limiting language “MUST BE MORE THAN” or “CANNOT BE MORE THAN.” Therefore, whether or not a certain feature or element were limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” or variants thereof do NOT necessarily refer to the same embodiments. For example, language such as “some embodiments include a feature” followed by “some embodiments include an element” does NOT necessarily admit that both of the feature and the element are included in all of the same embodiments.

Unless otherwise specified, one or more particular features and/or elements described in connection with one or more embodiments may be found in one embodiment, or may be found in more than one embodiment, or may be found in all embodiments, or may be found in no embodiments.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any and all details set forth herein are used in the context of some embodiments and therefore should NOT be necessarily taken as limiting factors to the attached claims. Any descriptions of elements and/or features and/or the materials used to create those elements or features, or examples or methods included in the descriptions of the various embodiments are nonlimiting and are given as an illustration only. Accordingly, the embodiments can be manufactured, distributed, used, practiced, and carried out in numerous ways.

The attached claims and their legal equivalents can be realized in the context of embodiments other than the ones used as illustrative examples in the description herein.

Referring to the several views of the drawings, the online system for sampling nightclub activity is shown in accordance with some embodiments. In each of these embodiments, the online system for sampling nightclub activity is generally indicated as 10.

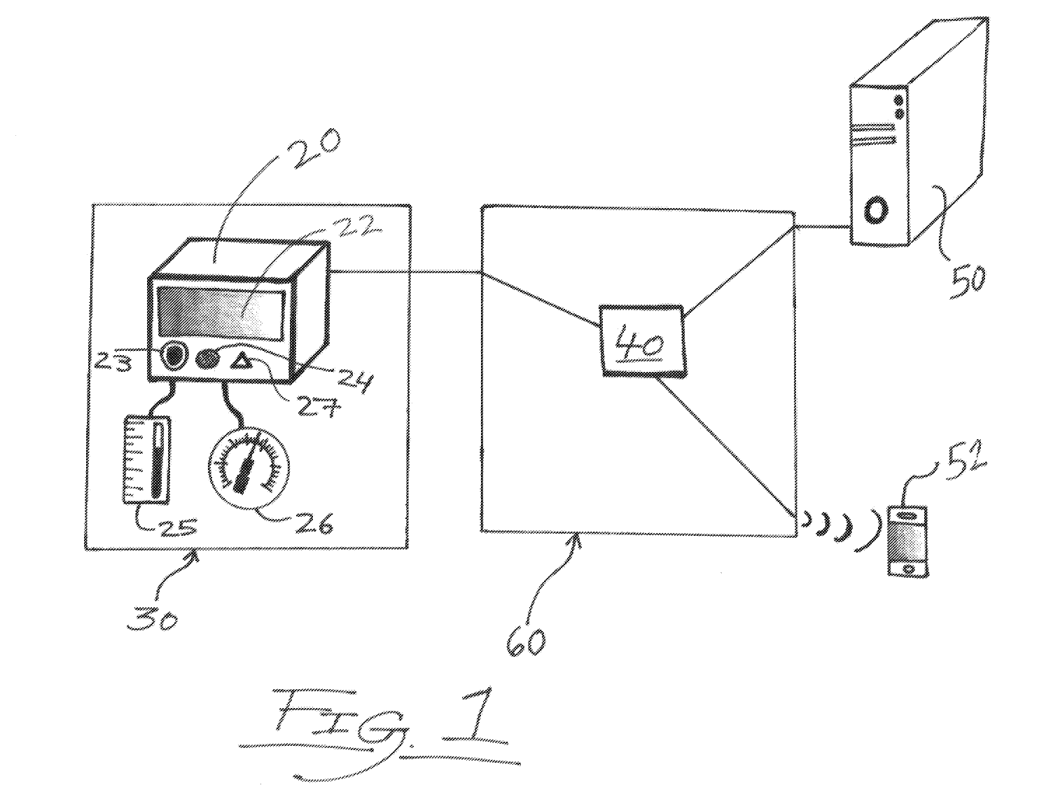

Reference is now made to FIG. 1. The online system for sampling nightclub activity 10 includes a data-collection device 20. The data-collection device 20 has a control panel 22. The control panel 22 may be a LCD monitor with physical switches and/or buttons, or it may be a touch screen, or any suitable variant thereof. The data-collection device 20 is connected to a group of sensors including a thermal imaging camera 23, a microphone 24, one or more thermometers 25, one or more hygrometers 26, and a light sensor 27. The data-collection device 20 and the connected sensors are installed within a desired, pre-determined establishment 30 (e.g. a restaurant, nightclub, etc.).

The control panel 22 controls the operations of the data-collection device 20 and the associated sensors. The thermal imaging camera 23 takes infrared video feed of the desired area. Infrared video feed is desired over normal video feed because of reasons of privacy (i.e. people currently in the establishment might not want their presence being made publicly available). The microphone 24 produces a corresponding audio feed of the desired area. One or more thermometers 25 and hygrometers 26 produce temperature and humidity measurements for the establishment's atmosphere for users to see, as well as provide a means for calibrating the thermal imaging camera 23. Light sensor 27 provides users with an indication of the lighting level of the establishment (this is important because the thermal imaging camera 23 will not give an indication of the lighting level).

All of the information collected by the data-collection device 20 is uploaded to a website 40 made publicly available on the internet 60. The website 40 contains information from at least one data-collection device 20, and preferably from many devices 20 across many different establishments 30. The information on the website 40 is presented and organized to be made viewable from a personal computer 50 or a phone 52 or any other suitable device at a home, office, etc. as long as that device has an active connection to the internet 60.

The website 40 may include a system for registered users of the website to rate the various relevant establishments in order to provide users with an additional means for comparing establishments and deciding where to go based on their needs.

Throughout the detailed description and the accompanying drawings enclosed herein, some embodiments have been shown, described and detailed, wherein a variety of possible elements and/or features may be formed and configured in different ways. Accordingly, any and all possible combinations of the elements and/or features described in accordance with these various embodiments may be desirable to manufacturers and/or may help to more successfully meet customers' specific needs and/or preferences. Consequently, any and all possible combinations of the features or elements of one embodiment or more than one embodiment or all embodiments mentioned herein are fully considered within the spirit and scope of the attached claims and their legal equivalents.

Thus, some embodiments of an online system for sampling nightclub activity have been disclosed. Other embodiments are contemplated and envisioned, and therefore it is recognized that departures from the embodiments described in this disclosure may certainly exist within the spirit and scope of the attached claims and their legal equivalents. Those having an ordinary skill in the will envision other possible variations and modifications to features and/or elements of the embodiments, and they will envision other possible embodiments, all of which may fall within the spirit and scope of the attached claims. The spirit and scope of the attached claims is therefore NOT limited by the descriptions and illuminations of the embodiments that have already been presented, but rather the spirit and scope can only be defined by the attached claims and their legal equivalents as interpreted under the doctrine of equivalents. Variations, alternatives, adjustments, modifications, tunings, and deviations from the embodiments of the instant disclosure are fully contemplated and envisioned within the spirit and scope of the attached claims.

What is claimed is:

1. An online system for previewing and sampling nightclub activity comprising:
a group of sensors having at least one sensor, the group comprising:
at least one thermal imaging camera;
at least one microphone;
a data-collection device for collecting data from group of sensors, wherein the data-collection device is connected to all of the sensors in the group of sensors, and may be located within an establishment; and
wherein the data-collection device is connected to the internet such that data collected from the group of sensors may be uploaded to users who are also connected to the internet.

2. The online system as recited in claim 1 wherein the group of sensors further comprises at least one thermometer.

3. The online system as recited in claim 2 wherein the group of sensors further comprises at least one hygrometer.

4. The online system as recited in claim 3 wherein the group of sensors further comprises at least one light sensor.

5. The online system as recited in claim 4 wherein the data collected from the group of sensors is uploaded to a publicly accessible website.

6. The online system as recited in claim 5, wherein the data may be made available for users to view on the publicly accessible website.

7. The online system as recited in claim 6, wherein the users may view the data stored on the website through a personal electronic device that is capable of connecting to the internet and browsing webpages.

8. The online system as recited in claim 7, wherein the personal electronic device is a personal computer.

9. The online system as recited in claim 7 wherein the personal electronic device is a cellular phone with internet-browsing capability.

10. The online system as recited in claim 7 wherein the establishment is a recreational establishment.

11. The online system as recited in claim 10 wherein the recreational establishment is some variant of a night club.

12. The online system as recited in claim 7 wherein the establishment is a restaurant.

13. The online system as recited in claim 7 wherein the data-collection device includes a control panel for changing settings of the device or of at least one of the group of sensors connected to the device.

14. The online system as recited in claim 13 wherein the control panel includes at least one of physical switches and buttons and a LCD screen.

15. The online system as recited in claim 13 wherein the control panel is a touch screen.

16. The online system as recited in claim 7 wherein the publicly accessible website includes a system of rating the relevant establishments in order to provide users with an additional means of comparing establishments and deciding where to spend their time based on their needs.
